(19) United States
(12) Patent Application Publication
(10) Pub. No.: US 2026/0367881 A1
(43) Pub. Date: Nov. 19, 2026

(54) Unified Platform for Developing and Operating Applications in a Cloud-Based System

(71) Applicant: Zscaler, Inc., San Jose, CA (US)

(72) Inventors: John Chanak, San Jose, CA (US); Omar Jaber, Seattle, WA (US); Srinivas Kavuri, San Jose, CA (US); Vadim Tarnavsky, San Jose, CA (US)

(73) Assignee: Zscaler, Inc., San Jose, CA (US)

(21) Appl. No.: 19/209,098

(22) Filed: May 15, 2025

(51) Int. Cl. G06F 8/35

(52) U.S. Cl. CPC G06F 8/35

(57) ABSTRACT

Systems and methods for a unified platform for developing and operating applications in a cloud-based system include a Common Information Model (CIM) for defining enterprise objects and their relationships, the CIM being extensible to include attributes, metadata, context, and versioning for objects; a Data Access Layer (DAL) coupled to one or more data stores, the DAL comprising multiple modular layers configured to abstract data store implementation details and provide a unified API for accessing data; a declarative model framework for facilitating intent-based application workflows, the framework including an object catalog, execution services, and APIs to coordinate the creation, modification, and propagation of objects across services; and one or more shared services reusable across a plurality of applications.

### FIELD OF THE DISCLOSURE

The present disclosure generally relates to network and cloud security. More particularly, the present disclosure relates to systems and methods for a unified platform for developing and operating applications in a cloud-based system.

### BACKGROUND OF THE DISCLOSURE

In modern cloud-based systems, enterprises increasingly rely on distributed services and applications to deliver functionality and manage critical data. However, the development and management of these distributed systems present several challenges. Each service often operates in isolation, with its own data access patterns, API design, and infrastructure integration, leading to significant fragmentation. This fragmentation results in duplicated effort, inconsistencies, and inefficiencies across engineering teams, as well as a degraded experience for customers who must interact with disjointed systems. Traditional approaches rely on service-specific constructs for defining and managing core enterprise concepts, such as policies, configurations, and data objects. These constructs often result in a lack of standardization, requiring redundant implementations for critical components like policy engines, AI/ML services, data stores, and APIs. Additionally, systems that do not have a consistent way to define, access, and share data face scalability, security, and performance issues, particularly when managing sensitive data like PII or critical business rules. To address these shortcomings, the present invention introduces a unified platform for developing and operating applications within a cloud-based system.

### BRIEF SUMMARY OF THE DISCLOSURE

The present disclosure relates to systems and methods for a unified platform for developing and operating applications. In various embodiments, the present disclosure includes a method having steps, a processing device configured to implement the steps, a cloud-based system configured to implement the steps, and as a non-transitory computer-readable medium storing instructions for programming one or more processors to execute the steps. The steps include defining one or more enterprise objects using a Common Information Model (CIM) of the unified platform to ensure standardization across one or more cloud services; enabling the application to access data using a Data Access Layer (DAL) of the unified platform, wherein the data is abstracted from one or more physical data stores and uniformly managed across shards; and enabling the application to leverage one or more shared services of the unified platform to eliminate redundant infrastructure development and enable feature reuse.

The steps can further include wherein the one or more enterprise objects include any of policies, events, and tenant configurations. The one or more shared services can include any of a policy engine and an Artificial Intelligence (AI) / Machine Learning (ML) engine. The steps can include configuring the application to respond to real-time events by receiving telemetry data processed through an AI/ML shared service, which publishes anomaly detections to an event store of the unified platform. The steps can include configuring the application to evaluate an event against policy rules maintained through a shared policy engine of the unified service. The steps can include configuring the application to enforce remediation actions based on matched policy rules, including actions such as updating firewall rules, blocking IP addresses, or generating admin alerts. All objects can be versioned, ensuring compatibility between shared services of the unified platform.

Various embodiments include a unified platform for developing and operating applications in a cloud-based system, the unified platform including a Common Information Model (CIM) for defining enterprise objects and their relationships, the CIM being extensible to include attributes, metadata, context, and versioning for objects; a Data Access Layer (DAL) coupled to one or more data stores, the DAL comprising multiple modular layers configured to abstract data store implementation details and provide a unified API for accessing data; a declarative model framework for facilitating intent-based application workflows, the framework including an object catalog, execution services, and APIs to coordinate the creation, modification, and propagation of objects across services; one or more shared services reusable across a plurality of applications;

The DAL can further include a connection management sub-layer configured to manage data store connections, connection pooling, failover, and replication; a sharding management sub-layer configured to map physical data store partitions to abstract shard identifiers, facilitating logical data access; a query builder sub-layer configured to translate high-level Application Programming Interface (API) function calls into database-specific queries or commands tailored to the underlying data store; a data protection sub-layer configured to obfuscate or encrypt sensitive data, using configurable encryption methodologies; and a throttling and flow control mechanism configured to regulate and restrict incoming data requests based on pre-determined thresholds or adaptive data store performance metrics. The throttling and flow control mechanism can support fixed-rate throttling and adaptive throttling based on data store Key Performance Indicators (KPIs), including connection pool usage, response times, error rates, and defined limits. The declarative model framework can include a declarative object model and catalog configured to define and organize enterprise objects; declarative execution services configured to orchestrate operations to create, modify, replicate, and propagate objects across services and data stores; and a declarative model Application Programming Interface (API) enabling users and services to perform high-level, intent-based operations, including the creation, deletion, onboarding, and configuration of enterprise resources. The CIM and the declarative model framework can facilitate normalized declaration, discovery, sharing, and interaction with objects between different services, eliminating the need for application-specific schemas or workflows. The unified platform can include a versioned object protocol that is adapted to track changes to enterprise objects by creating a new object version for every update. The shared services can include a shared policy engine for defining, evaluating, and enforcing policy rules across cloud-based applications. The shared services can include an Artificial Intelligence (AI) / Machine Learning (ML) shared service for processing real-time telemetry, anomaly detection, and automated decision-making. The shared services can include a data analytics shared service for generating historical and real-time insights into system behavior, policy enforcement, and event outcomes. The unified platform can include a versioned object cache for caching objects by version number, the cache supporting global and regional deployments, and capable of issuing near-real-time notifications for object version updates. The one or more data stores can include a persistent data store for storing enterprise objects, policies, and multi-tenant configurations. The one or more data stores can include a transient data store for streaming real-time data and caching results. The unified platform can include a health and metrics reporting layer configured to collect and report system health metrics, including query latency, connection errors, and resource utilization; integrate with external observability or monitoring systems to provide real-time diagnostics; and operate independently of service-specific health reporting frameworks to ensure consistency across platform components.

### BRIEF DESCRIPTION OF THE DRAWINGS

The present disclosure is illustrated and described herein with reference to the various drawings, in which like reference numbers are used to denote like system components/method steps, as appropriate, and in which:

FIG. 1A is a network diagram of three example network configurations of cybersecurity monitoring and protection of a user.

FIG. 1B is a logical diagram of the cloud operating as a zero-trust platform.

FIG. 2 is a block diagram of a server.

FIG. 3 is a block diagram of a computing device.

FIG. 4 is a diagram of an exemplary network configuration illustrating an application on computing devices configured to operate through the cloud.

FIG. 5 is a diagram representing an architecture for a unified platform.

FIG. 6 is a diagram of a Data Access Layer (DAL) architecture.

FIG. 7 is a flowchart of a process for utilizing a unified platform for developing an application for a cloud-based system.

### DETAILED DESCRIPTION OF THE DISCLOSURE

Again, the present disclosure relates to systems and methods for a unified platform which aims to build an integrated, cohesive platform that addresses various challenges by bringing consistency across all facets of a cloud-based system. This unified platform ensures that distinct services are well-integrated and offer a seamless experience for engineering teams, operations professionals, and end-users alike. It extends across key dimensions, including UIs, APIs, data management, configuration, and infrastructure layers, creating a common foundation to unify platform services.

### §1.0 Cybersecurity monitoring and protection examples

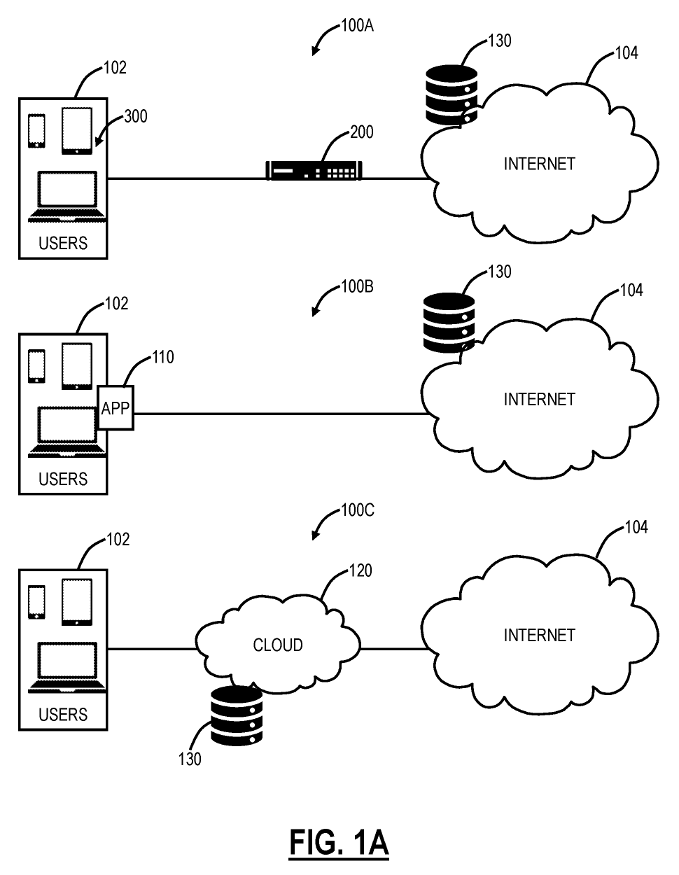

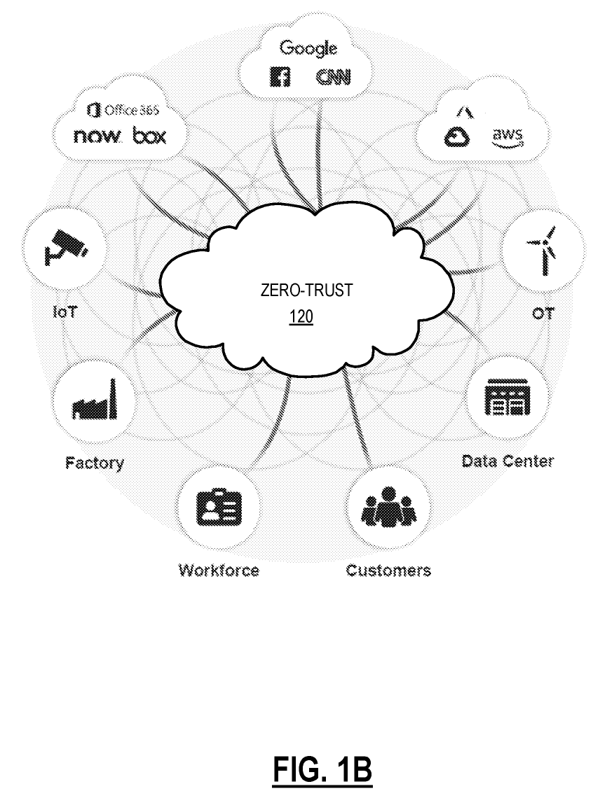

FIG. 1A is a network diagram of three example network configurations 100A, 100B, 100C of cybersecurity monitoring and protection of an endpoint 102. Those skilled in the art will recognize these are some examples for illustration purposes, there may be other approaches to cybersecurity monitoring (as well as providing generalized services), and these various approaches can be used in combination with one another as well as individually. Also, while shown for a single endpoint 102, practical embodiments will handle a large volume of endpoints 102, including multi-tenancy. In this example, the endpoint 102 communicates on the Internet 104, including accessing cloud services, Software-as-a-Service, etc. (each may be offered via computing resources, such as, e.g., using one or more servers 200 as illustrated in FIG. 2).

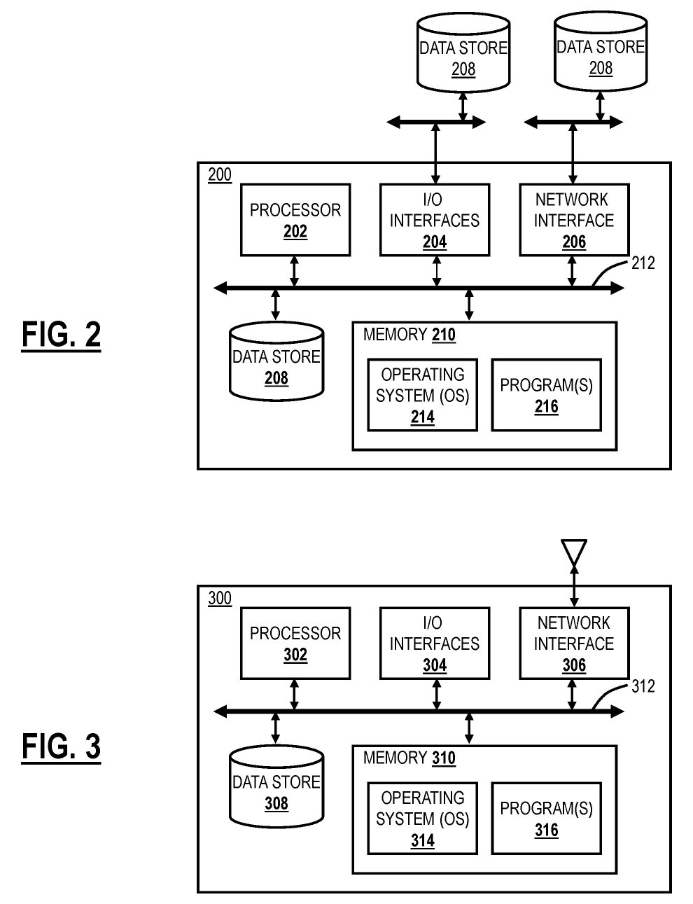

Note, the term endpoint 102 is used herein to refer to any computing device (see FIG. 3 for an example computing device 300) which can communicate on a network. The endpoint 102 can be associated with a user and include laptops, tablets, mobile phones, desktops, etc. Further, the endpoint can also mean machines, workloads, IoT devices, or simply anything associated with the company that connects to the Internet, a Local Area Network (LAN), etc.

As part of offering cybersecurity through these example network configurations 100A, 100B, 100C, there is a large amount of cybersecurity data obtained. Various embodiments of the present disclosure focus on using this cybersecurity data along with a customer’s data to perform various security tasks including developing customer machine learning models and other security platforms of the like.

The network configuration 100A includes a server 200 located between the endpoint 102 and the Internet 104. For example, the server 200 can be a proxy, a gateway, a Secure Web Gateway (SWG), Secure Internet and Web Gateway, Secure Access Service Edge (SASE), Secure Service Edge (SSE), Cloud Application Security Broker (CASB), etc. The server 200 is illustrated located inline with the endpoint 102 and configured to monitor the endpoint 102. In other embodiments, the server 200 does not have to be inline. For example, the server 200 can monitor requests from the endpoint 102 and responses to the endpoint 102 for one or more security purposes, as well as allow, block, warn, and log such requests and responses. The server 200 can be on a local network associated with the endpoint 102 as well as external, such as on the Internet 104. Also, while described as a server 200, this can also be a router, switch, appliance, virtual machine, etc. The network configuration 100B includes an application 110 that is executed on the computing device 300. The application 110 can perform similar functionality as the server 200, as well as coordinated functionality with the server 200 (a combination of the network configurations 100A, 100B). Finally, the network configuration 100C includes a cloud service 120 configured to monitor the endpoint 102 and perform security-as-a-service. Of course, various embodiments are contemplated herein, including combinations of the network configurations 100A, 100B, 100C together.

The cybersecurity monitoring and protection can include firewall, intrusion detection and prevention, Uniform Resource Locator (URL) filtering, content filtering, bandwidth control, Domain Name System (DNS) filtering, protection against advanced threat (malware, spam, Cross-Site Scripting (XSS), phishing, etc.), data protection, sandboxing, antivirus, and any other security technique. Any of these functionalities can be implemented through any of the network configurations 100A, 100B, 100C. A firewall can provide Deep Packet Inspection (DPI) and access controls across various ports and protocols as well as being application and user aware. The URL filtering can block, allow, or limit website access based on policy for a user, group of users, or entire organization, including specific destinations or categories of URLs (e.g., gambling, social media, etc.). The bandwidth control can enforce bandwidth policies and prioritize critical applications such as relative to recreational traffic. DNS filtering can control and block DNS requests against known and malicious destinations.

The intrusion prevention and advanced threat protection can deliver full threat protection against malicious content such as browser exploits, scripts, identified botnets and malware callbacks, etc. The sandbox can block zero-day exploits (just identified) by analyzing unknown files for malicious behavior. The antivirus protection can include antivirus, antispyware, antimalware, etc. protection for the endpoints 102, using signatures sourced and constantly updated. The DNS security can identify and route command-and-control connections to threat detection engines for full content inspection. The DLP can use standard and/or custom dictionaries to continuously monitor the endpoints 102, including compressed and/or Transport Layer Security (TLS) or Secure Sockets Layer (SSL)-encrypted traffic.

In typical embodiments, the network configurations 100A, 100B, 100C can be multi-tenant and can service a large volume of the endpoints 102. Newly discovered threats can be promulgated for all tenants practically instantaneously. The endpoints 102 can be associated with a tenant, which may include an enterprise, a corporation, an organization, etc. That is, a tenant is a group of users who share a common grouping with specific privileges, i.e., a unified group under some IT management. The present disclosure can use the terms tenant, enterprise, organization, enterprise, corporation, company, etc. interchangeably and refer to some group of endpoints 102 under management by an IT group, department, administrator, etc., i.e., some group of endpoints 102 that are managed together. One advantage of multi-tenancy is the visibility of cybersecurity threats across a large number of endpoints 102, across many different organizations, across the globe, etc. This provides a large volume of data to analyze, use machine learning techniques on, develop comparisons, etc. The present disclosure can use the term “service provider” to denote an entity providing the cybersecurity monitoring and a “customer” as a company (or any other grouping of endpoints 102).

Of course, the cybersecurity techniques above are presented as examples. Those skilled in the art will recognize other techniques are also contemplated herewith. That is, any approach to cybersecurity that can be implemented via any of the network configurations 100A, 100B, 100C. Also, any of the network configurations 100A, 100B, 100C can be multi-tenant with each tenant having its own endpoints 102 and configuration, policy, rules, etc.

### §1.1 Cloud monitoring

The cloud 120 can scale cybersecurity monitoring and protection with near-zero latency on the endpoints 102. Also, the cloud 120 in the network configuration 100C can be used with or without the application 110 in the network configuration 100B and the server 200 in the network configuration 100A. Logically, the cloud 120 can be viewed as an overlay network between endpoints 102 and the Internet 104 (and cloud services, SaaS, etc.). Previously, the IT deployment model included enterprise resources and applications stored within a data center (i.e., physical devices) behind a firewall (perimeter), accessible by employees, partners, contractors, etc. on-site or remote via Virtual Private Networks (VPNs), etc. The cloud 120 replaces the conventional deployment model. The cloud 120 can be used to implement these services in the cloud without requiring the physical appliances and management thereof by enterprise IT administrators. As an ever-present overlay network, the cloud 120 can provide the same functions as the physical devices and/or appliances regardless of geography or location of the endpoints 102, as well as independent of platform, operating system, network access technique, network access provider, etc.

There are various techniques to forward traffic between the endpoints 102 and the cloud 120. A key aspect of the cloud 120 (as well as the other network configurations 100A, 100B) is that all traffic between the endpoints 102 and the Internet 104 is monitored. All of the various monitoring approaches can include log data 130 accessible by a management system, management service, analytics platform, and the like. For illustration purposes, the log data 130 is shown as a data storage element and those skilled in the art will recognize the various compute platforms described herein can have access to the log data 130 for implementing any of the techniques described herein for risk quantification. In an embodiment, the cloud 120 can be used with the log data 130 from any of the network configurations 100A, 100B, 100C, as well as other data from external sources.

The cloud 120 can be a private cloud, a public cloud, a combination of a private cloud and a public cloud (hybrid cloud), or the like. Cloud computing systems and methods abstract away physical servers, storage, networking, etc., and instead offer these as on-demand and elastic resources. The National Institute of Standards and Technology (NIST) provides a concise and specific definition which states cloud computing is a model for enabling convenient, on-demand network access to a shared pool of configurable computing resources (e.g., networks, servers, storage, applications, and services) that can be rapidly provisioned and released with minimal management effort or service provider interaction. Cloud computing differs from the classic client-server model by providing applications from a server that are executed and managed by a client’s web browser or the like, with no installed client version of an application required. Centralization gives cloud service providers complete control over the versions of the browser-based and other applications provided to clients, which removes the need for version upgrades or license management on individual client computing devices. The phrase “Software-as-a-Service” (SaaS) is sometimes used to describe application programs offered through cloud computing. A common shorthand for a provided cloud computing service (or even an aggregation of all existing cloud services) is “the cloud.” The cloud 120 contemplates implementation via any approach known in the art.

The cloud 120 can be utilized to provide example cloud services, including Zscaler Internet Access (ZIA), Zscaler Private Access (ZPA), Zscaler Workload Segmentation (ZWS), and/or Zscaler Digital Experience (ZDX), all from Zscaler, Inc. (the assignee and applicant of the present application). Also, there can be multiple different clouds 120, including ones with different architectures and multiple cloud services. The ZIA service can provide the access control, threat prevention, and data protection. ZPA can include access control, microservice segmentation, etc. The ZDX service can provide monitoring of user experience, e.g., Quality of Experience (QoE), Quality of Service (QoS), etc., in a manner that can gain insights based on continuous, inline monitoring. For example, the ZIA service can provide a user with Internet Access, and the ZPA service can provide a user with access to enterprise resources instead of traditional Virtual Private Networks (VPNs), namely ZPA provides Zero Trust Network Access (ZTNA). Those of ordinary skill in the art will recognize various other types of cloud services are also contemplated.

### §1.2 Zero trust

FIG. 1B is a logical diagram of the cloud 120 operating as a zero-trust platform. Zero trust is a framework for securing organizations in the cloud and mobile world that asserts that no user or application should be trusted by default. Following a key zero trust principle, least-privileged access, trust is established based on context (e.g., user identity and location, the security posture of the endpoint, the app or service being requested) with policy checks at each step, via the cloud 120. Zero trust is a cybersecurity strategy where security policy is applied based on context established through least-privileged access controls and strict user authentication—not assumed trust. A well-tuned zero trust architecture leads to simpler network infrastructure, a better user experience, and improved cyberthreat defense.

Establishing a zero-trust architecture requires visibility and control over the environment's users and traffic, including that which is encrypted; monitoring and verification of traffic between parts of the environment; and strong multi-factor authentication (MFA) approaches beyond passwords, such as biometrics or one-time codes. This is performed via the cloud 120. Critically, in a zero-trust architecture, a resource's network location is not the biggest factor in its security posture anymore. Instead of rigid network segmentation, your data, workflows, services, and such are protected by software-defined micro segmentation, enabling you to keep them secure anywhere, whether in your data center or in distributed hybrid and multi-cloud environments.

The core concept of zero trust is simple: assume everything is hostile by default. It is a major departure from the network security model built on the centralized data center and secure network perimeter. These network architectures rely on approved IP addresses, ports, and protocols to establish access controls and validate what's trusted inside the network, generally including anybody connecting via remote access VPN. In contrast, a zero-trust approach treats all traffic, even if it is already inside the perimeter, as hostile. For example, workloads are blocked from communicating until they are validated by a set of attributes, such as a fingerprint or identity. Identity-based validation policies result in stronger security that travels with the workload wherever it communicates—in a public cloud, a hybrid environment, a container, or an on-premises network architecture.

Because protection is environment-agnostic, zero trust secures applications and services even if they communicate across network environments, requiring no architectural changes or policy updates. Zero trust securely connects users, devices, and applications using business policies over any network, enabling safe digital transformation. Zero trust is about more than user identity, segmentation, and secure access. It is a strategy upon which to build a cybersecurity ecosystem.

At its core are three tenets:

Terminate every connection: Technologies like firewalls use a “passthrough” approach, inspecting files as they are delivered. If a malicious file is detected, alerts are often too late. An effective zero trust solution terminates every connection to allow an inline proxy architecture to inspect all traffic, including encrypted traffic, in real time—before it reaches its destination—to prevent ransomware, malware, and more.

Protect data using granular context-based policies: Zero trust policies verify access requests and rights based on context, including user identity, device, location, type of content, and the application being requested. Policies are adaptive, so user access privileges are continually reassessed as context changes.

Reduce risk by eliminating the attack surface: With a zero-trust approach, users connect directly to the apps and resources they need, never to networks (see ZTNA). Direct user-to-app and app-to-app connections eliminate the risk of lateral movement and prevent compromised devices from infecting other resources. Plus, users and apps are invisible to the internet, so they cannot be discovered or attacked.

### §1.3 Log data

With the cloud 120 as well as any of the network configurations 100A, 100B, 100C, the log data 130 can include a rich set of statistics, logs, history, audit trails, and the like related to various endpoint 102 transactions. Generally, this rich set of data can represent activity by an endpoint 102. This information can be for multiple endpoints 102 of a company, organization, etc., and analyzing this data can provide a wealth of information as well as training data for machine learning models.

The log data 130 can include a large quantity of records used in a backend data store for queries. A record can be a collection of tens of thousands of counters. A counter can be a tuple of an identifier (ID) and value. As described herein, a counter represents some monitored data associated with cybersecurity monitoring. Of note, the log data can be referred to as sparsely populated, namely a large number of counters that are sparsely populated (e.g., tens of thousands of counters or more, and possible orders of magnitude or more of which are empty). For example, a record can be stored every time period (e.g., an hour or any other time interval). There can be millions of active endpoints 102 or more. Examples of the sparsely populated log data can be the Nanolog system from Zscaler, Inc., the applicant.

Also, such data is described in the following:

Commonly-assigned U.S. Patent No. 8,429,111, issued Apr. 23, 2013, and entitled “Encoding and compression of statistical data,” the contents of which are incorporated herein by reference, describes compression techniques for storing such logs,

Commonly-assigned U.S. Patent No. 9,760,283, issued Sep. 12, 2017, and entitled “Systems and methods for a memory model for sparsely updated statistics,” the contents of which are incorporated herein by reference, describes techniques to manage sparsely updated statistics utilizing different sets of memory, hashing, memory buckets, and incremental storage, and

Commonly-assigned U.S. Patent Application No. 16/851,161, filed Apr. 17, 2020, and entitled “Systems and methods for efficiently maintaining records in a cloud-based system,” the contents of which are incorporated herein by reference, describes compression of sparsely populated log data.

A key aspect here is that the cybersecurity monitoring is rich and provides a wealth of information to determine various assessments of cybersecurity. In some embodiments, the log data 130 can be referred to as weblogs or the like. Of note, with various cybersecurity monitoring techniques via the network configurations 100A, 100B, 100C, as well as with other network configurations, the log data 130 is a rich repository of endpoint 102 activity. Unlike websites, specific cloud services, application providers, etc., cybersecurity monitoring can log almost all of a user’s 102 activity. That is, the log data 130 is not merely confined to specific activity (e.g., a user’s 102 social networking activity on a specific site, a user’s 102 search requests on a specific search engine, etc.).

### §2.0 Example server architecture

FIG. 2 is a block diagram of a server 200, which may be used as a destination on the Internet, for the network configuration 100A, etc. The server 200 may be a digital computer that, in terms of hardware architecture, generally includes a processor 202, input/output (I/O) interfaces 204, a network interface 206, a data store 208, and memory 210. It should be appreciated by those of ordinary skill in the art that FIG. 2 depicts the server 200 in an oversimplified manner, and a practical embodiment may include additional components and suitably configured processing logic to support known or conventional operating features that are not described in detail herein. The components (202, 204, 206, 208, and 210) are communicatively coupled via a local interface 212. The local interface 212 may be, for example, but not limited to, one or more buses or other wired or wireless connections, as is known in the art. The local interface 212 may have additional elements, which are omitted for simplicity, such as controllers, buffers (caches), drivers, repeaters, and receivers, among many others, to enable communications. Further, the local interface 212 may include address, control, and/or data connections to enable appropriate communications among the aforementioned components.

The processor 202 is a hardware device for executing software instructions. The processor 202 may be any custom made or commercially available processor, a Central Processing Unit (CPU), an auxiliary processor among several processors associated with the server 200, a semiconductor-based microprocessor (in the form of a microchip or chipset), or generally any device for executing software instructions. When the server 200 is in operation, the processor 202 is configured to execute software stored within the memory 210, to communicate data to and from the memory 210, and to generally control operations of the server 200 pursuant to the software instructions. The I/O interfaces 204 may be used to receive user input from and/or for providing system output to one or more devices or components.

The network interface 206 may be used to enable the server 200 to communicate on a network, such as the Internet 104. The network interface 206 may include, for example, an Ethernet card or adapter or a Wireless Local Area Network (WLAN) card or adapter. The network interface 206 may include address, control, and/or data connections to enable appropriate communications on the network. A data store 208 may be used to store data. The data store 208 may include any volatile memory elements (e.g., random access memory (RAM, such as DRAM, SRAM, SDRAM, and the like)), nonvolatile memory elements (e.g., ROM, hard drive, tape, CDROM, and the like), and combinations thereof. Moreover, the data store 208 may incorporate electronic, magnetic, optical, and/or other types of storage media. In one example, the data store 208 may be located internal to the server 200, such as, for example, an internal hard drive connected to the local interface 212 in the server 200. Additionally, in another embodiment, the data store 208 may be located external to the server 200 such as, for example, an external hard drive connected to the I/O interfaces 204 (e.g., SCSI or USB connection). In a further embodiment, the data store 208 may be connected to the server 200 through a network, such as, for example, a network-attached file server.

The memory 210 may include any volatile memory elements (e.g., random access memory (RAM, such as DRAM, SRAM, SDRAM, etc.)), nonvolatile memory elements (e.g., ROM, hard drive, tape, CDROM, etc.), and combinations thereof. Moreover, the memory 210 may incorporate electronic, magnetic, optical, and/or other types of storage media. Note that the memory 210 may have a distributed architecture, where various components are situated remotely from one another but can be accessed by the processor 202. The software in memory 210 may include one or more software programs, each of which includes an ordered listing of executable instructions for implementing logical functions. The software in the memory 210 includes a suitable Operating System (O/S) 214 and one or more programs 216. The operating system 214 essentially controls the execution of other computer programs, such as the one or more programs 216, and provides scheduling, input-output control, file and data management, memory management, and communication control and related services. The one or more programs 216 may be configured to implement the various processes, algorithms, methods, techniques, etc. described herein. Those skilled in the art will recognize the cloud 120 ultimately runs on one or more physical servers 200, virtual machines, etc..

### §3.0 Example computing device architecture

FIG. 3 is a block diagram of a computing device 300, which may be realize an endpoint 102. Specifically, the computing device 300 can form a device used by one of the endpoints 102, and this may include common devices such as laptops, smartphones, tablets, netbooks, personal digital assistants, cell phones, e-book readers, Internet-of-Things (IoT) devices, servers, desktops, printers, televisions, streaming media devices, storage devices, and the like, i.e., anything that can communicate on a network. The computing device 300 can be a digital device that, in terms of hardware architecture, generally includes a processor 302, I/O interfaces 304, a network interface 306, a data store 308, and memory 310. It should be appreciated by those of ordinary skill in the art that FIG. 3 depicts the computing device 300 in an oversimplified manner, and a practical embodiment may include additional components and suitably configured processing logic to support known or conventional operating features that are not described in detail herein. The components (302, 304, 306, 308, and 302) are communicatively coupled via a local interface 312. The local interface 312 can be, for example, but not limited to, one or more buses or other wired or wireless connections, as is known in the art. The local interface 312 can have additional elements, which are omitted for simplicity, such as controllers, buffers (caches), drivers, repeaters, and receivers, among many others, to enable communications. Further, the local interface 312 may include address, control, and/or data connections to enable appropriate communications among the aforementioned components.

The processor 302 is a hardware device for executing software instructions. The processor 302 can be any custom made or commercially available processor, a CPU, an auxiliary processor among several processors associated with the computing device 300, a semiconductor-based microprocessor (in the form of a microchip or chipset), or generally any device for executing software instructions. When the computing device 300 is in operation, the processor 302 is configured to execute software stored within the memory 310, to communicate data to and from the memory 310, and to generally control operations of the computing device 300 pursuant to the software instructions. In an embodiment, the processor 302 may include a mobile-optimized processor such as optimized for power consumption and mobile applications. The I/O interfaces 304 can be used to receive user input from and/or for providing system output. User input can be provided via, for example, a keypad, a touch screen, a scroll ball, a scroll bar, buttons, a barcode scanner, and the like. System output can be provided via a display device such as a Liquid Crystal Display (LCD), touch screen, and the like.

The network interface 306 enables wireless communication to an external access device or network. Any number of suitable wireless data communication protocols, techniques, or methodologies can be supported by the network interface 306, including any protocols for wireless communication. The data store 308 may be used to store data. The data store 308 may include any volatile memory elements (e.g., random access memory (RAM, such as DRAM, SRAM, SDRAM, and the like)), nonvolatile memory elements (e.g., ROM, hard drive, tape, CDROM, and the like), and combinations thereof. Moreover, the data store 308 may incorporate electronic, magnetic, optical, and/or other types of storage media.

The memory 310 may include any volatile memory elements (e.g., random access memory (RAM, such as DRAM, SRAM, SDRAM, etc.)), nonvolatile memory elements (e.g., ROM, hard drive, etc.), and combinations thereof. Moreover, the memory 310 may incorporate electronic, magnetic, optical, and/or other types of storage media. Note that the memory 310 may have a distributed architecture, where various components are situated remotely from one another, but can be accessed by the processor 302. The software in memory 310 can include one or more software programs, each of which includes an ordered listing of executable instructions for implementing logical functions. In the example of FIG. 3, the software in the memory 310 includes a suitable operating system 314 and programs 316. The operating system 314 essentially controls the execution of other computer programs and provides scheduling, input-output control, file and data management, memory management, and communication control and related services. The programs 316 may include various applications, add-ons, etc. configured to provide end-user functionality with the computing device 300. For example, example programs 316 may include, but not limited to, a web browser, social networking applications, streaming media applications, games, mapping and location applications, electronic mail applications, financial applications, and the like. The application 110 can be one of the example programs.

### §4.0 Application for traffic forwarding and monitoring

Again, the network configuration 100B includes an application 110 that is executed on the computing device 300. The application 110 can perform similar functionality as the server 200, as well as coordinated functionality with the server 200 (a combination of the network configurations 100A, 100B). Of course, various embodiments are contemplated herein, including combinations of the network configurations 100A, 100B, 100C together. For example, the application 110 can perform similar functionality as the cloud 120, as well as coordinated functionality with the cloud 120.

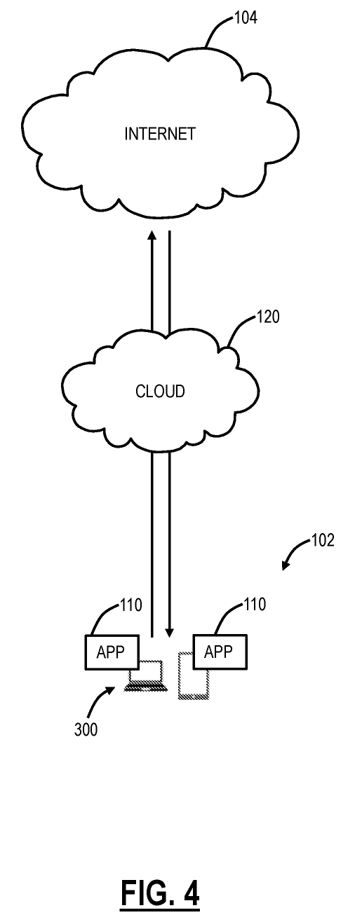

FIG. 4 is a network diagram of an exemplary network configuration illustrating an application 110 on computing devices 300 configured to operate through the cloud 120. Different types of computing devices 300 are proliferating, including Bring Your Own Device (BYOD) as well as IT-managed devices. The conventional approach for a computing device 300 to operate with the cloud 120 as well as for accessing enterprise resources includes complex policies, VPNs, poor user experience, etc. The application 110 can automatically forward user traffic with the cloud 120 as well as ensuring that security and access policies are enforced, regardless of device, location, operating system, or application. The application 110 automatically determines if a user 102 is looking to access the open Internet 104, a SaaS app, or an internal app running in public, private, or the datacenter and routes mobile traffic through the cloud 120. The application 110 can support various cloud services, including ZIA, ZPA, ZDX, etc., allowing the best in class security with zero trust access to internal applications. As described herein, the application 110 can also be referred to as a connector application.

The application 110 is configured to auto-route traffic for seamless user experience. This can be protocol as well as application-specific, and the application 110 can route traffic with a nearest or best fit node of the cloud 120. Further, the application 110 can detect trusted networks, allowed applications, etc. and support secure network access. The application 110 can also support the enrollment of the computing device 300 prior to accessing applications, the internet, or any services provided by the cloud 120. The application 110 can uniquely detect the users 102 based on fingerprinting the user device 300, using criteria like device model, platform, operating system, device posture, etc. The application 110 can support Mobile Device Management (MDM) functions, allowing IT personnel to deploy and manage the computing devices 300 seamlessly. This can also include the automatic installation of client and SSL certificates during enrollment. Finally, the application 110 provides visibility into device and app usage of the user 102 of the computing device 300.

The application 110 supports a secure, lightweight tunnel between the computing device 300 and the cloud 120. For example, the lightweight tunnel can be HTTP-based. With the application 110, there is no requirement for PAC files, an IPSec VPN, authentication cookies, or user 102 setup.

### §5.0 Cloud-based platform

The cloud-based platform (i.e., the cloud 120, cloud-based system, platform), along with similar solutions, serves as a highly intelligent Zero Trust Network (ZTN) and data protection platform designed for securing modern, digitally-transformed enterprises. At its core, the platform embodies the principles of zero trust, where no entity, whether a user, device, or application, is inherently trusted. Instead, trust is established dynamically based on identity, device posture, and contextual factors, ensuring that access is granted on a strictly need-to-know basis. This architecture allows the cloud-based platform to deliver secure, seamless access to data, applications, and resources, whether they reside on public or private networks. The platform operates as a security and connectivity layer that is cloud-native, scalable, and capable of supporting hybrid and distributed work environments.

One of the distinguishing features of the cloud-based platform is its ability to integrate advanced capabilities such as configuration management, Artificial Intelligence (AI), Machine Learning (ML), data protection, and real-time threat detection. Through sophisticated AI/ML-driven methods, the platform continuously monitors network activity, detects anomalies, and proactively identifies potential threats such as ransomware, malware, or unauthorized access attempts. This intelligent approach ensures that both users and enterprise assets remain protected from evolving cyberthreats while maintaining the operational agility demanded in today’s fast-moving business environments.

In addition to threat detection, the cloud-based platform offers robust data protection mechanisms, empowering organizations to secure sensitive information and enforce compliance with data governance policies. By leveraging cloud-native Data Loss Prevention (DLP) and granular access controls, the platform mitigates unauthorized data exfiltration and reduces the risk of breaches. Organizations can trust that their critical data and applications are safeguarded, even as employees connect from remote locations or Bring Your Own Device (BYOD) environments.

Furthermore, the cloud-based platform simplifies configuration management by centralizing policy enforcement and network visibility within a single interface. This ease of use enhances operational efficiency, enabling IT teams to define and manage security policies consistently across users, devices, and applications. This unified approach ensures that security policies are applied uniformly, regardless of where users connect from or what network resources they use.

Overall, the cloud-based platform represents a next-generation solution for secure digital transformation. It effectively integrates zero trust principles with cutting-edge AI/ML capabilities to protect data, applications, and users across various environments. By delivering secure access to resources on public or private networks while simplifying network and security operations, the cloud-based platform ensures organizations remain agile, secure, and prepared to tackle the complexities of the modern threat landscape.

The current state of the cloud-based platform and its associated products and services reveals a significant degree of fragmentation, inefficiencies, and redundancies that impact engineering productivity, time-to-market, cost, and user experience. At its core, the products and services, such as the described security services, that implement the platform are heavily distributed, requiring seamless data sharing and access to support complex, large-scale features. However, the inconsistency in how data access, integration, storage, and movement are defined and implemented across services creates substantial challenges. For instance, deploying applications like a Unified Visibility and Management (UVM) application necessitates data integration across other services such as ZIA, ZPA, and other services. Today, each of these services approaches data differently, leading to disparate integrations, custom testing, and rollout requirements. Consequently, this extends development timelines, increases the operational support burden, and ultimately delays time-to-market for critical features. In short, there is no unified platform solution to define, store, and move data at scale across services, forcing engineering teams to define their own solutions independently.

The challenge also extends to the lack of a unified definition for security and configuration constructs across services. For example, the policy object model definitions vary significantly between ZPA, ZIA, and Risk360 (a service for visualizing risk across a tenants environment), resulting in each team defining, storing, and exposing policies to public APIs and User Interfaces (UIs) differently. This inconsistency adds cognitive complexity for both internal developers and platform users, who must learn multiple implementations of the same concept. For customers, this inconsistency degrades their experience as administrators, requiring them to adopt different approaches for otherwise similar tasks, leading to unnecessary friction and an overall sense of fragmentation across the platform.

In the absence of a unified platform, engineering teams prioritize feature execution over foundational platform improvements to meet aggressive timelines. This often leads to teams implementing siloed solutions, such as deploying redundant AI/ML systems for specific features. Over time, this approach creates multiple independently implemented AI/ML pipelines that provide inconsistent results to users, further compounding fragmentation issues. Such redundancy not only confuses platform users but also adds unnecessary complexity to internal operations, with different teams maintaining different implementations of the same technology.

Moreover, engineering teams face significant operational and production challenges due to the lack of a standardized platform. Deploying critical infrastructure components such as databases, storage, and distributed caches to support new features demands specialized expertise and significant engineering time. However, database and storage development is not a commonly shared skill within every engineering team, requiring years of experience to master. This localized ownership leads to operational inefficiencies, increased engineering costs, and delayed feature delivery timelines. Furthermore, critical yet non-core services run sub-optimally because asking every engineering organization to master advanced concepts like distributed storage, AI/ML, and caching, on top of core product development, is neither scalable nor practical. This results in a direct impact on the platform’s ability to scale effectively, maintain reliability and availability, and meet engineering cost targets.

Ultimately, the fragmented state of the cloud-based platform’s services introduces high levels of technical debt, burdens engineering teams, and significantly increases time-to-market for new products and features. The absence of consistent architectural patterns and reusable services also bleeds into the customer experience, where administrators sense this fragmentation and, at times, are vocal about their dissatisfaction. This creates a clear need for a unified solution to consolidate and standardize the platform’s services and capabilities.

### §6.0 Unified platform

The proposed solution is a unified platform which aims to build an integrated, cohesive platform that addresses the described challenges by bringing consistency across all facets of the cloud-based system. This unified platform will ensure that distinct services are well-integrated and offer a seamless experience for engineering teams, operations professionals, and end-users alike. It will extend across key dimensions, including the UI, API, data management, configuration, and infrastructure layers, creating a common foundation to unify platform services.

By implementing this unified approach, the cloud-based platform will enable streamlined development and operations processes that enhance the scale, reliability, and availability of the platform while significantly reducing cost and engineering complexity. A unified platform promises consistent policies, reusable components, and optimized data sharing, fostering greater efficiency across engineering teams and providing an integrated experience for customers. Ultimately, this vision paves the way for a highly-scalable, secure, consistent, and cohesive platform that will enable the cloud-based platform to deliver innovative solutions faster, more reliably, and with a superior user experience.

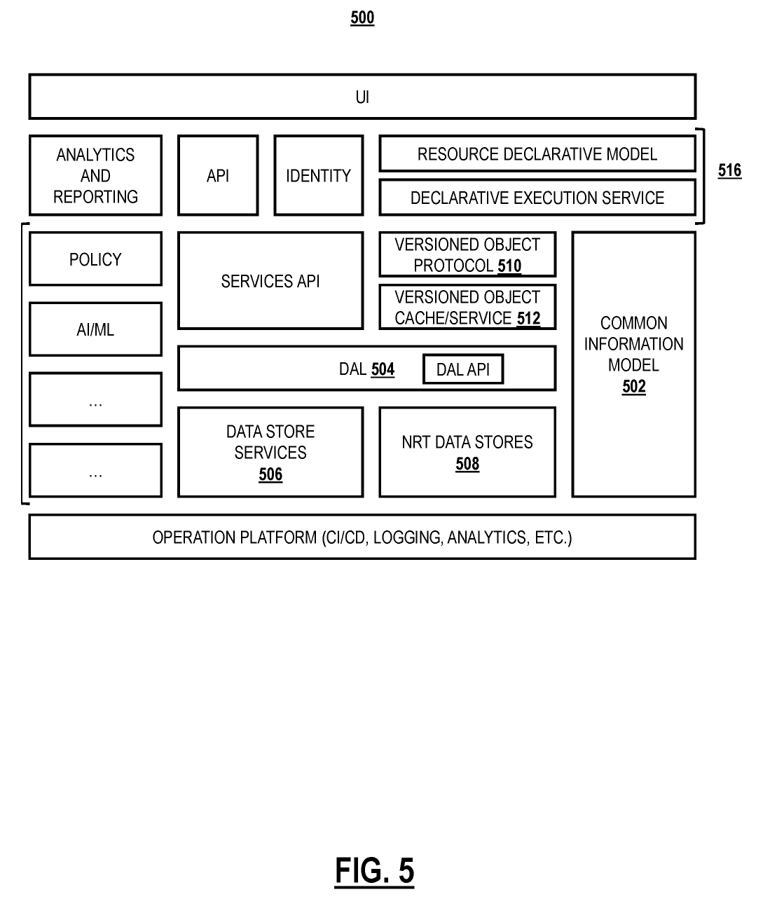

FIG. 5 is a diagram representing an architecture for a unified platform 500. The diagram represents the proposed architecture for the unified platform 500, highlighting its various integral "layers" or components that work cohesively to address existing fragmentation and build a streamlined, scalable system. These layers incorporate foundational services and functionalities that enable uniform access to data, shared services, and reusable core constructs, while simplifying operations for engineering teams and enhancing the customer experience.

The Common Information Model (CIM) 502 serves as the backbone of the unified platform's data architecture. It is an extensible object data model designed to define enterprise objects and their relationships in a consistent and standardized manner. Both public and internal APIs leverage CIM 502 to exchange messages and move data efficiently across services. A key advantage of CIM 502 is its extensibility, allowing engineering teams to declare new data objects or derive and extend existing ones as needed to meet evolving requirements. While not every service object needs to be represented in CIM 502, all objects defining core enterprise concepts must adhere to this model.

Central to the CIM 502 is its ability to unify foundational constructs across services. For example, enterprise-wide concepts like policy, rule, and tenant are key constructs that must be standardized through CIM 502. This standardization is critical to achieving unified functionalities, such as adopting the same policy model across security services. Such consistency is the first step toward creating a single, common policy engine, enabling a seamless and unified experience across the platform.

At the core of data management, the Data Access Layer (DAL) 504 abstracts the underlying data storage specifics, such as location and topology, from client services. This abstraction provides a unified and consistent view of enterprise data by returning data objects instead of low-level database constructs like rows and columns. For core objects such as those defined using CIM 502, the API interfaces are built directly on the CIM 502, ensuring interoperability and consistency across services.

In essence, the DAL 504 bridges the gap between the platform’s data stores and services, simplifying data access while hiding the complexity of storage or topology. By providing a uniform API, DAL 504 reduces the operational burden on engineering teams while implementing a scalable and reliable mechanism to access and manipulate data.

The Data Store Services 506 layer manages persistent data storage infrastructure, providing a globally and regionally deployed, highly available, and reliable system. This includes a variety of persistent storage types, such as Relational Database Management Systems (RDBMS) and Not Only Structured Query Language (NoSQL) databases, tailored to handle structured and semi-structured data, respectively. While schema and Data Definition Language (DDL) operations are controlled via a dedicated control plane API, access to the data itself is managed exclusively through the DAL API, ensuring tight integration and consistency between the two layers.

By abstracting the complexity of persistent storage, this layer ensures seamless utilization of reliable data repositories while supporting the scalability and availability required for modern, cloud-based applications.

The Near-Real-Time (NRT) Data Stores 508 layer focuses on managing transient data used for high-speed, real-time applications. This layer provides globally and regionally deployed, highly available ephemeral data stores such as Kafka, Redis, and Elasticsearch, which are optimized for tasks like event streaming, caching, and search indexing. The APIs, capacities, and control plane operations for these services are fully managed within this layer, simplifying their adoption by other platform components.

NRT Data Stores 508 are indispensable for enabling timely processing and delivery of data, such as real-time notifications, analytics, and machine-learning operations, ensuring that services remain responsive and performant.

The Versioned Object Protocol 510 introduces a robust versioning mechanism to track changes to enterprise objects across the platform’s services while maintaining compatibility. Each time an object, such as a policy or System for Cross-Domain Identity Management (SCIM) property, undergoes a change, a new version is created. This protocol explicitly declares whether changes are forward- or backward-compatible and provides mechanisms for rolling back or rolling forward as needed.

By implementing this protocol, the platform ensures a high degree of traceability and compatibility across its services, enabling effective management of object changes without disruption to dependent systems or users.

The Versioned Object Cache 512 layer complements the Versioned Object Protocol 510 by providing a globally and regionally deployed caching system for versioned objects. This highly available and reliable caching service supports near-real-time (NRT) push notifications to inform subscribed services of changes to object versions. This layer ensures that services consuming common enterprise objects receive updates instantly and operate efficiently without repeated data fetches.

Through effective caching and real-time synchronization, this layer enhances performance and scalability across the unified platform 500.

The unified platform 500 incorporates a suite of Shared Services 514, which are independent, reusable services that form key building blocks of the platform’s ecosystem. Examples of these shared services include the Policy Engine, AI/ML Services, and others. Instead of engineering teams building separate implementations of these services for individual products like ZPA, ZIA, etc., the unified platform 500 centralizes these functionalities, enabling greater reuse and consistency. For instance, products leverage the Policy Shared Service to define and enforce policies, eliminating the need for duplicative, product-specific implementations of similar capabilities.

This approach reduces complexity, fosters reusability, and ensures a consistent experience across the platform.

The Declarative Model 516 introduces an advanced method for defining and managing platform services and their object models. Unlike procedural approaches, where tasks must be executed step by step, the Declarative Model 516 allows callers to simply describe the desired outcome. For example, instead of procedural APIs to create or enroll a ZPA tenant, a Declarative Model 516 allows users to describe the tenant’s configuration, and the system manages the required actions to deliver that outcome.

The Declarative Model 516 is composed of three sub-layers:

Declarative Object Model and Catalog – A centralized catalog storing object models defined by services.

Declarative Model Execution Services – Responsible for coordinating execution to achieve the desired declarative outcomes.

Declarative Model API – Abstracts complexity by providing a uniform API for accessing and managing objects.

A service only needs to define its object model and add it to the catalog, along with internal API support for Create, Read, Update, and Delete (CRUD) operations. The execution and external API are provided generically by the platform, reducing the burden on individual teams while maintaining architectural consistency.

The unified platform 500 architecture brings together a suite of highly integrated and reusable components that solve existing issues of fragmentation, operational inefficiency, and inconsistency. By introducing layers like the Common Information Model (CIM) 502, Data Access Layer (DAL) 504, Versioned Object Protocol 510, Shared Services 514, and the Declarative Model 516, the platform aims to simplify engineering processes, enhance scalability, and streamline customer experiences. This cohesive system ensures a consistent approach to data, policies, infrastructure, and APIs across services, enabling faster time-to-market, reduced engineering costs, and a robust, scalable unified platform that aligns with the demands of a modern digital enterprise.

### §6.1 Data Access Layer (DAL)

As described above, the DAL is an important component of the present unified platform 500. The DAL is a critical architectural component designed to sit between the core business logic of services and the underlying data store, providing a standardized and abstracted way to access and manage data. The data store can vary widely, encompassing both persistent and transient data storage systems, including examples such as RDBMS (Relational Databases), Redis (in-memory data stores), and S3 (object storage). By abstracting away the internal implementation details of these data stores, the DAL enables application layers to focus solely on working with data, rather than having to manage the complexity of database connections, query optimization, or distributed storage intricacies.

At the heart of the DAL’s functionality is its ability to handle key operational and technical responsibilities associated with data management. These responsibilities include:

Connection Management and Scalability: DAL manages and optimizes data store connections at scale, ensuring the application layer is free from the hassles of connection pooling or performance tuning.

Query Management: It generates and executes data store-specific queries while maintaining the desired consistency model, sparing application developers from writing data store-centric code.

Data Mapping: DAL maps the logical data model to the underlying physical data store, abstracting away storage specifics without requiring knowledge of business logic from the application developers.

Error Management: Handling errors, communication failures, logging, and retries with different data store types is centralized in DAL, as opposed to expecting every individual business application to independently implement these functions.

Support for Advanced Features: DAL provides built-in support for critical features such as transactions, different levels of access control, consistency models, and support for distributed data storage systems.

Unified API and Data Model: A common API is provided to simplify reading and writing data from various data stores, ensuring a consistent developer experience across all services.

Currently, the implementation of data stores across several cloud-based platform products, such as ZPA, ZIA, ZDK (Cloud Browser Isolation), ZMS (Management Services), Risk360, etc., is fragmented and inconsistent. Each product employs its own bespoke approach to operational data store implementation, APIs, and storage management, creating several challenges including:

Lack of Shared Design Patterns: Products operate with distinct design patterns and object models, making it difficult to establish a cohesive and interoperable framework for data management.

Inconsistent Deployment Models: Each service has its own deployment model leading to operational complexities.

Varied Performance Optimizations: The way each service optimizes data store performance, error handling, and transaction execution differs significantly, resulting in redundancy and inefficiency.

Disparate APIs: APIs for accessing data are inconsistent across services, lacking standardized design principles, basic expectations, or even common method signatures.

Inconsistent HA/DR Support: High-Availability (HA) and Disaster Recovery (DR) features such as data replication and failover mechanisms are either unsupported or implemented differently across services and, in many cases, are not tested regularly.

Minimal Reusability: Teams building and managing operational data stores don't collaborate on common layers, meaning critical capabilities, such as error handling, are completely separate and different in implementation from those in other services.

The overarching problem statement for DAL is to design a common, layered approach to data access that decouples the business logic of cloud-based platform services from the low-level implementation details of data stores. The primary objective is to transform data access into a simple service-level API call that integrates seamlessly with business logic, rather than forcing engineering teams to approach each data store as a unique integration project.

By adopting this unified data access design pattern, the platform can ensure consistency across services and enable several benefits. DAL, much like any robust design pattern, becomes a reusable, reliable architectural concept with broad applicability. For example, in database systems, the concept of transaction logs is well understood. While implementations can vary (e.g., MySQL, PostgreSQL, or SQL Server each implement transaction logs differently), the core elements like transaction record and Log Sequence Number (LSN) remain consistent. DAL as a concept serves a similar purpose, establishing foundational principles of data access while allowing flexibility in data store implementation.

When implemented correctly, DAL can transform how services interact with data, offering a single point of standardization that promotes best practices across the platform. These include proper service integration, component reusability, faster, safer development cycles, and reduced technical debt. Decoupling business logic from data store operations ensures services can integrate seamlessly without being constrained by underlying storage complexities. By offering a reusable abstraction layer, DAL enhances component sharing across products and reduces duplication of effort. With a unified API and design pattern, developers can focus on innovation and feature development without getting bogged down in low-level details, leading to a shorter time-to-market and a more resilient platform. By centralizing error handling, query management, and performance optimization in DAL, teams can avoid inconsistencies and inefficiencies that would otherwise accumulate into technical debt.

Ultimately, DAL is far more than an API layer, it is a common, layered data access design pattern that simplifies data interactions across a diverse range of cloud services, enhances reliability and scalability, and paves the way for the cloud-based platform to operate with improved efficiency, agility, and consistency at scale. Through proper implementation of DAL, the platform achieves its vision of enabling modular, reusable architectures that minimize operational burden and foster long-term innovation.

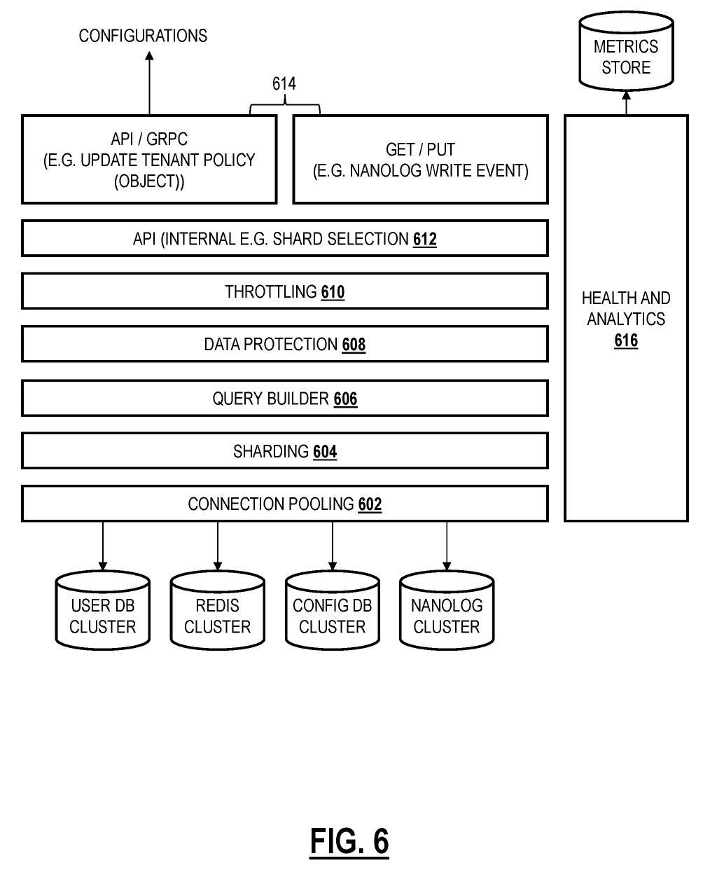

FIG. 6 is a diagram of a Data Access Layer (DAL) architecture. When implementing a DAL service, the framework is divided into several key sub-layers, each designed to serve as a building block to ensure effective separation between the data store and the data consumers. These sub-layers serve distinct purposes, enabling proper scoping, reusability, secure data handling, and support for complex data topologies. Each of these sub-layers plays an essential role in abstracting the intricacies of the data store while enabling a standardized, reusable, and scalable approach to data access.

The Connection Management & Pooling sub-layer 602 operates closest to the data store and is the most data store-specific component of all the DAL layers. This sub-layer is independent of application-specific constructs, meaning it has no knowledge of business logic concepts such as policies or tenants. Its role is exclusively tied to managing the lifecycle of data store connections and ensuring efficient utilization of resources. Key responsibilities at this sub-layer include managing data store connections and implementing connection pooling to optimize data access performance, collecting and reporting data store Key Performance Indicators (KPI) and metrics for operational insights, monitoring data store health and orchestrating remediation tasks, such as automated maintenance jobs (e.g., cron jobs), and supporting high availability through data store failover, replication, and recovery mechanisms, ensuring resilience against outages or failures. This sub-layer abstracts the technical complexities of connecting to and maintaining data stores, laying the groundwork for seamless operation at higher levels.

The Sharding Management sub-layer 604 introduces awareness of how data is distributed across multiple data store nodes or clusters. Sharding is a method for partitioning data to improve scalability and performance, and this sub-layer provides the abstraction needed to manage it effectively. This sub-layer is responsible for configuring or hardcoding shard allocation rules based on specific services or requirements. For example, a database handling user data (User DB) may always partition data by tenant identification. This sub-layer also maps physical database clusters to logical ShardIDs, enabling applications to reference shards without needing to know the underlying topology. This sub-layer further coordinates with the connection management sub-layer 602 to determine which shard a connection belongs to, ensuring that queries are routed to the correct data store. By abstracting shard allocation and routing into this sub-layer, services can operate independently of the lower-level complexities of data store partitioning.

The Query Builder sub-layer 606 is one of the most powerful and reusable sub-layers within the DAL architecture 600. Its primary role is to translate high-level API calls into data store-specific queries while adhering to the platform’s data model. This sub-layer is responsible for interpreting public API requests (e.g., Update Tenant Policy) and generating the corresponding SQL queries or commands required to perform the desired operations within a shard or data store, promoting reusability by supporting multiple levels of query abstraction, enabling multiple services to share common query logic, and ensuring that query consistency, performance optimization, and security (e.g., SQL injection prevention) are applied universally for all API calls that rely on this sub-layer. By centralizing query generation, the Query Builder significantly reduces the burden on individual services and ensures consistency and performance optimization across the platform.

The Data Protection sub-layer 608 provides the functionality required to secure sensitive data through obfuscation or encryption. At this sub-layer, public-facing data that has been marked as "protected" can be processed to meet the platform’s security and privacy requirements. For instance, sensitive data may be encrypted or obfuscated based on data store-specific configurations. The encryption or obfuscation method is determined by the service implementing the DAL, but having a shared and generic implementation encourages reusability and consistency. This sub-layer acts as a safeguard, ensuring data protection across all services, while providing flexibility for different implementations depending on security or compliance needs.

The Throttling & Flow Control sub-layer 610 is designed to protect both the service and the underlying data store by regulating the number of incoming requests. Proper throttling ensures that the data store is not overwhelmed by excessive traffic, which could degrade performance or cause service interruptions. Key functionalities include managing the rate of incoming requests, determining whether a request should be served or rejected based on predefined thresholds, supporting per-API limits to allow fine-grained control over throttling policies for public and internal APIs, and supporting either a fixed-rate throttling mechanism or an advanced adaptive throttling implementation based on data store KPIs, resource usage, and predefined service SLAs. This sub-layer ensures system stability under heavy load, while its adaptive capabilities enable intelligent scaling and resource optimization.

The Internal API sub-layer 612 defines APIs required for service functionality but not intended for public consumption. These internal APIs act as a bridge for accessing sensitive data store resources or performing backend operations. For example, If the platform supports Field-Level Encryption (FLE) where keys are stored in a secure data store, the Internal API manages the retrieval and handling of these keys without exposing them to external services or processes. It facilitates operations needed by the Data Protection sub-layer 608, such as encrypting and decrypting sensitive customer-provided data securely. By isolating internal operations from public APIs, this sub-layer ensures tighter security and separation of concerns in the DAL architecture.

The DAL Public API 614 is the most visible sub-layer of the architecture and serves as the primary interface for all data access operations. It enables external services to interact with data in a consistent and standardized manner. The Public API 614 includes two main components:

Data Model: Defines the schema of the data objects managed by the API, providing a logical representation for external consumers.

API Functions: Supports specific operations, such as creating, retrieving, updating, and deleting data. These operations can be exposed in two ways including an HTTP-like API, offering operations such as PUT, GET, UPDATE, and DELETE for general-purpose data management and well-defined API calls, such as UpdateTenantPolicy (tenantID, policyObject), which align with core platform constructs and leverage the underlying DAL sub-layers to translate calls into efficient data operations. This API sub-layer is critical for creating hardened, standardized interfaces for data access, enabling services to interact seamlessly with the platform’s data model.

The Health & Metrics Reporting sub-layer 616 provides a standardized way to monitor the health of the DAL instance and its associated services. This sub-layer focuses on reporting service metrics and KPIs (e.g., connection pool usage, query latency) to external monitoring tools like Victoria Metrics or other observability platforms. This sub-layer also ensures the reporting mechanism is generic, avoiding coupling with non-DAL services to maintain independence and reusability. The sub-layer further supports active monitoring and diagnostics to ensure that the DAL operates efficiently and meets SLA requirements. This sub-layer ensures operational transparency, providing critical insights to engineering and operations teams.

The implementation of a DAL service/layer involves integrating a powerful combination of sub-layers, each with a focus on abstraction, modularity, and reusability. From Connection Management & Pooling to Health & Metrics Reporting, each sub-layer is designed to address specific aspects of data access while promoting separation of concerns and reducing complexity. By standardizing how data is accessed, stored, protected, and monitored, the DAL transforms data access into a seamless, secure, and efficient process. When implemented correctly, this common, layered architecture enables service integration, promotes faster development cycles, enhances data security, and reduces technical debt, driving the overall scalability and reliability of the platform.

### §6.2 Unified platform implementation

Again, the present disclosure introduces a unified platform 500 that delivers significant benefits across engineering, feature development, and customer experience. By addressing the inefficiencies and fragmentation currently present in disjoint services and application constructs, this invention provides a robust foundation for streamlined development, faster feature delivery, and an improved user experience.

The unified platform 500 enables engineering teams to focus on building capabilities that deliver direct customer value rather than diverting resources to redundant efforts such as creating and maintaining similar components across multiple product teams. Centralizing shared services and foundational infrastructure relieves individual teams from concern over building or running core components, such as data store access layers, policy engines, or distributed system recovery mechanisms. This alignment empowers developers to devote their time and expertise to innovation rather than system maintenance or duplication of effort. By leveraging these shared tools and constructs, the engineering burden is significantly reduced, improving overall efficiency and productivity.

The ability to design, implement, and deploy new features rapidly is significantly improved with the unified platform 500. Through normalized approaches for declaring, discovering, accessing, and sharing objects between different products, the unified platform removes the bottlenecks of bespoke integrations and inconsistencies. The platform is anchored by a Common Information Model (CIM) 502, which provides standardized objects complete with attributes, context, versioning, and relationships. This allows teams to collaborate seamlessly across services and focus on building product features using common foundations rather than reinventing core capabilities. Additionally, Shared Services 514 enhance availability and reliability, ensuring smooth infrastructure support for rapid feature rollouts.

The unified platform 500 takes significant steps to improve system reliability and availability, which are essential for ensuring a stable and always-on experience for both internal teams and external customers. Several mechanisms contribute to these benefits. Centralized, resilient data storage systems form the backbone of the platform ensure that data is reliable and accessible even during system disruptions or unexpected load increases. In the event of data loss or corruption, the platform provides well-defined recovery processes, enabling application-level restoration with minimal downtime and ensuring consistency in customer-facing and internal workflows. These infrastructure improvements smooth out operational uncertainties, ensuring the unified platform is dependable for critical business needs.

The inventiveness of this platform lies not only in standardizing backend technologies but also in delivering a cohesive and intuitive experience that directly improves customer interactions. Developers can design and build applications, encompassing policies, User Interfaces (UI), and public APIs, using unified platform constructs, as opposed to the previous state where applications were dependent on fragmented and disjoint service-specific constructs. This aligned approach ensures that products share a consistent logic, behavior, and user-facing design, reducing the frustration caused by inconsistencies and fragmented interactions. Customers benefit from a platform that feels unified and seamless, resulting in easier administration and a more intuitive engagement with core services.

The present invention provides an integrated platform that significantly enhances engineering workflows, accelerates feature delivery, strengthens system reliability, and improves the end-user experience. By establishing foundational elements such as the CIM 502, centralized shared services 514, the DAL 504, and resilient data stores, the unified platform removes inefficiencies and fragmentation, paving the way for scalable and secure digital transformation. This holistic approach not only empowers engineering teams to do more with fewer resources but also translates directly into tangible value for customers, making the unified platform a transformative step toward greater business agility and innovation.

An embodiment of the unified platform 500 can be illustrated through the development of a Threat Detection and Policy Management Application within the cloud-based platform. This application combines multiple services to allow customers to define security policies, detect threats in real-time, and enforce automated remediation across distributed environments. The unified platform streamlines the application by leveraging reusable components, the Common Information Model (CIM), Shared Services, and standardized Data Access Layers (DAL) to simplify development, reduce complexity, and enhance scalability and user experience.

This application leverages several key components that ensure a unified, efficient, and scalable system. The CIM standardizes the representation of core enterprise objects such as Policies, Threat Events, Tenant Configurations, and Users. Instead of different teams defining custom schemas, the CIM provides a consistent structure, including object metadata, context, relationships, and versioning. For example, a Policy Object contains attributes like policyID, rules, scope, priority, and tenantID, while a Threat Event Object includes eventID, threatType, severityLevel, and associatedPolicyID. This uniform data model allows microservices interacting with policies, whether for definitions, updates, or enforcement, to operate cohesively.

The application also leverages shared services, reducing redundancy by integrating existing platform capabilities. The policy engine manages policy definitions, storage, evaluation, and enforcement, eliminating the need for a separate policy engine. AI/ML services enhance threat detection by analyzing real-time telemetry and identifying anomalies, removing the necessity of building an independent AI pipeline. Additionally, the data analytics service provides insights and historic reports on policy violations and remediation efforts, ensuring robust monitoring and compliance.

A critical aspect of this architecture is the DAL, which abstracts data storage complexities. It enables seamless interaction with both persistent data, such as policy definitions stored in an RDBMS, and transient data, like real-time threat events housed in Redis or Kafka. The query builder layer translates high-level API requests into SQL queries or Redis commands, while the sharding management layer ensures tenant-specific data is efficiently distributed and retrieved across data store clusters.

Another fundamental component utilized by the application is the declarative model, which allows the application to define high-level intents rather than procedural workflows. For instance, onboarding a new tenant is simplified as the declarative framework specifies the desired tenant configuration state, and the platform automatically provisions databases, instantiates tenants, and generates default policies. Similarly, policy updates are described as desired outcomes, ensuring that changes are propagated across relevant services without requiring intricate procedural logic.

Finally, the versioned object protocol ensures that objects like policies and threat events remain compatible across services. By versioning these objects, the system supports rollbacks, forward compatibility, and audit trails, ensuring smooth transitions when changes occur. This structured approach enhances system reliability, consistency, and adaptability across all interacting components.

In an example use case, a tenant of the cloud-based platform creates a custom threat policy via the unified platform. In this scenario, a tenant wants to configure a policy that automatically blocks IP addresses when a Distributed Denial of Service (DDoS) attack is detected and triggers an alert when the attack severity surpasses a defined threshold.

The unified platform workflow enables the customer to define this policy using a UI powered by the platform’s declarative framework. The customer specifies an IP address block policy, outlining conditions such as blocking IPs when traffic exceeds a certain threshold. Additionally, they set alert rules to trigger notifications based on severity levels. The CIM ensures that the policy object is consistently stored and represented, incorporating attributes like policyID, tenantID, rules, actions, and version. Using the policy engine shared service, these rules are then distributed to enforcement points, such as ZIA for internet traffic and ZPA for private access.

For real-time threat detection, distributed sensors and telemetry systems continuously collect raw threat data, including traffic analytics and IP logs. This data is processed by the AI/ML shared service, which identifies anomalies indicative of a DDoS attack. Upon detection, the system generates a threat event object and alerts the policy engine.

During automated response and enforcement, the policy engine evaluates the incoming threat event against the configured policy. If the conditions match, the engine issues commands to block the offending IP addresses using ZIA’s (or other cloud service) enforcement mechanisms. Simultaneously, the declarative model ensures that notifications are sent to the tenant’s admin team while updating relevant dashboards and reports.

Lastly, for data reporting, all policy enforcement actions and threat event metadata are stored in a persistent data store, accessed through the DAL. A shared data analytics service provides real-time insights, including details on the number of blocked IPs, attack duration, and overall traffic impact. This comprehensive approach ensures efficient threat detection, rapid response, and streamlined policy enforcement within the unified platform.

The policy engine, data analytics, and AI/ML services were reused from the shared services pool, eliminating the need for the application team to build these components from scratch. The DAL abstracted away the complexities of managing sharded databases and transient data stores, allowing the team to focus on delivering policy-related capabilities. Further, the use of standardized schemas in the CIM reduced development time for tenant configurations, policy definitions, and enforcement workflows by ensuring consistency and compatibility while the declarative model accelerated feature delivery by abstracting procedural setup steps for tenant onboarding and policy updates.

The use of highly available data stores and versioned objects ensured resiliency and consistency during real-time threat processing, even in cases of partial system failures while shared SLAs and failover mechanisms prevented downtime during heavy traffic surges or anomalies. The tenant admin could define policies, monitor enforcement, and review reports through a unified interface built on platform constructs, free from the inconsistencies of disjointed application integrations. Finally, real-time event detection and policy enforcement ensured immediate protection and minimal impact from events like DDoS attacks.

Overall, this embodiment illustrates how the unified platform 500 enables rapid, scalable development of a new threat detection and policy management application. By leveraging foundational layers like the CIM, declarative model, shared services, and DAL, the application delivers powerful customer-facing capabilities with minimal engineering overhead. The platform's unified architecture promotes component reuse, simplifies data management, and ensures reliability, speed, and consistency, setting a new standard for application development within the cloud-based ecosystem.

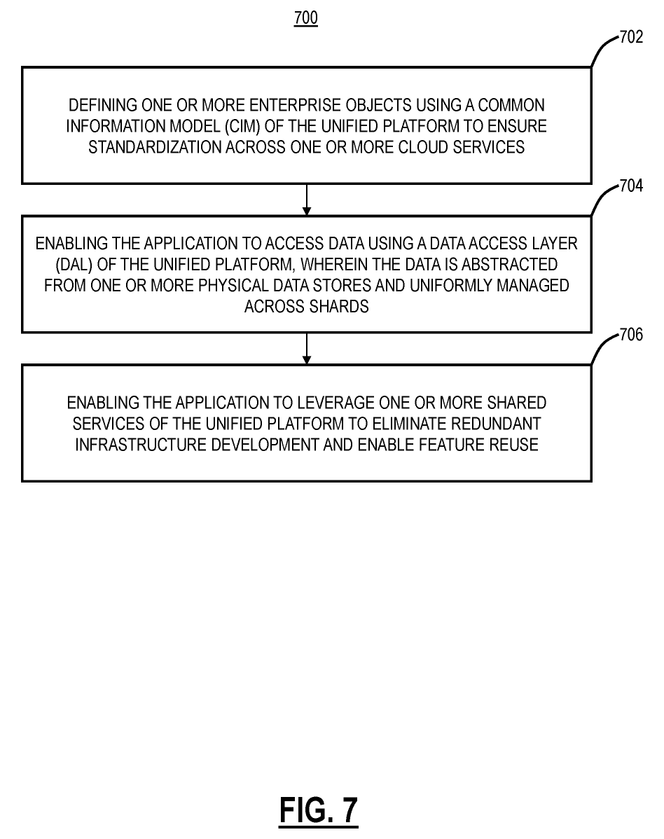

FIG. 7 is a flowchart of a process 700 for utilizing a unified platform for developing an application for a cloud-based system. The steps of process 700 include defining one or more enterprise objects using a Common Information Model (CIM) of the unified platform to ensure standardization across one or more cloud services (step 702); enabling the application to access data using a Data Access Layer (DAL) of the unified platform, wherein the data is abstracted from one or more physical data stores and uniformly managed across shards (step 704); and enabling the application to leverage one or more shared services of the unified platform to eliminate redundant infrastructure development and enable feature reuse (step 706).

The steps can further include wherein the one or more enterprise objects include any of policies, events, and tenant configurations. The one or more shared services can include any of a policy engine and an Artificial Intelligence (AI) / Machine Learning (ML) engine. The steps can include configuring the application to respond to real-time events by receiving telemetry data processed through an AI/ML shared service, which publishes anomaly detections to an event store of the unified platform. The steps can include configuring the application to evaluate an event against policy rules maintained through a shared policy engine of the unified service. The steps can include configuring the application to enforce remediation actions based on matched policy rules, including actions such as updating firewall rules, blocking IP addresses, or generating admin alerts. All objects can be versioned, ensuring compatibility between shared services of the unified platform.

### §6.0 Processing circuitry and non-transitory computer-readable mediums

Those skilled in the art will recognize that the various embodiments may include processing circuitry of various types. The processing circuitry might include, but are not limited to, general-purpose microprocessors; Central Processing Units (CPUs); Digital Signal Processors (DSPs); specialized processors such as Network Processors (NPs) or Network Processing Units (NPUs), Graphics Processing Units (GPUs); Field Programmable Gate Arrays (FPGAs); Programmable Logic Device (PLD), or similar devices. The processing circuitry may operate under the control of unique program instructions stored in their memory (software and/or firmware) to execute, in combination with certain non-processor circuits, either a portion or the entirety of the functionalities described for the methods and/or systems herein. Alternatively, these functions might be executed by a state machine devoid of stored program instructions, or through one or more Application-Specific Integrated Circuits (ASICs), where each function or a combination of functions is realized through dedicated logic or circuit designs. Naturally, a hybrid approach combining these methodologies may be employed. For certain disclosed embodiments, a hardware device, possibly integrated with software, firmware, or both, might be denominated as circuitry, logic, or circuits "configured to" or "adapted to" execute a series of operations, steps, methods, processes, algorithms, functions, or techniques as described herein for various implementations.

Additionally, some embodiments may incorporate a non-transitory computer-readable storage medium that stores computer-readable instructions for programming any combination of a computer, server, appliance, device, module, processor, or circuit (collectively “system”), each equipped with processing circuitry. These instructions, when executed, enable the system to perform the functions as delineated and claimed in this document. Such non-transitory computer-readable storage mediums can include, but are not limited to, hard disks, optical storage devices, magnetic storage devices, Read-Only Memory (ROM), Programmable Read-Only Memory (PROM), Erasable Programmable Read-Only Memory (EPROM), Electrically Erasable Programmable Read-Only Memory (EEPROM), Flash memory, etc. The software, once stored on these mediums, includes executable instructions that, upon execution by one or more processors or any programmable circuitry, instruct the processor or circuitry to undertake a series of operations, steps, methods, processes, algorithms, functions, or techniques as detailed herein for the various embodiments.

### §7.0 Conclusion

In this disclosure, including the claims, the phrases “at least one of” or “one or more of” when referring to a list of items mean any combination of those items, including any single item. For example, the expressions “at least one of A, B, or C,” “at least one of A, B, and C,” “one or more of A, B, or C,” and “one or more of A, B, and C” cover the possibilities of: only A, only B, only C, a combination of A and B, A and C, B and C, and the combination of A, B, and C. This can include more or fewer elements than just A, B, and C. Additionally, the terms “comprise,” “comprises,” “comprising,” “include,” “includes,” and “including” are intended to be open-ended and non-limiting. These terms specify essential elements or steps but do not exclude additional elements or steps, even when a claim or series of claims includes more than one of these terms.

Although operations, steps, instructions, blocks, and similar elements (collectively referred to as “steps”) are shown in the drawings, descriptions, and claims in a specific order, this does not imply they must be performed in that sequence unless explicitly stated. It also does not imply that all depicted operations are necessary to achieve desirable results. The drawings may schematically represent example processes as flowcharts or diagrams, and additional operations not shown can be included. In the drawings, descriptions, and claims, extra steps can occur before, after, simultaneously with, or between any of the illustrated, described, or claimed steps. Multitasking and parallel processing are also contemplated. Furthermore, the separation of system components or steps described should not be interpreted as mandatory for all implementations; also, components, steps, elements, etc. can be integrated into a single implementation or distributed across multiple implementations.

While this disclosure has been detailed and illustrated through specific embodiments and examples, it should be understood by those skilled in the art that numerous variations and modifications can perform equivalent functions or achieve comparable results. Such alternative embodiments and variations, even if not explicitly mentioned but that achieve the objectives and adhere to the principles disclosed herein, fall within the spirit and scope of this disclosure. Accordingly, they are envisioned and encompassed by this disclosure and are intended to be protected under the associated claims. In other words, the present disclosure anticipates combinations and permutations of the described elements, operations, steps, methods, processes, algorithms, functions, techniques, modules, circuits, and so on, in any conceivable manner—whether collectively, in subsets, or individually—thereby broadening the range of potential embodiments.

What is claimed is:

1. A unified platform for developing and operating applications in a cloud-based system, the unified platform comprising:
a Common Information Model (CIM) for defining enterprise objects and their relationships, the CIM being extensible to include attributes, metadata, context, and versioning for objects;
a Data Access Layer (DAL) coupled to one or more data stores, the DAL comprising multiple modular layers configured to abstract data store implementation details and provide a unified API for accessing data;
a declarative model framework for facilitating intent-based application workflows, the framework including an object catalog, execution services, and APIs to coordinate creation, modification, and propagation of objects across services; and
one or more shared services reusable across a plurality of applications.

2. The unified platform of claim 1, wherein the DAL further comprises:
a connection management sub-layer configured to manage data store connections, connection pooling, failover, and replication;
a sharding management sub-layer configured to map physical data store partitions to abstract shard identifiers, facilitating logical data access;
a query builder sub-layer configured to translate high-level Application Programming Interface (API) function calls into database-specific queries or commands tailored to an underlying data store;
a data protection sub-layer configured to obfuscate or encrypt sensitive data, using configurable encryption methodologies; and
a throttling and flow control mechanism configured to regulate and restrict incoming data requests based on pre-determined thresholds or adaptive data store performance metrics.

3. The unified platform of claim 2, wherein the throttling and flow control mechanism supports fixed-rate throttling and adaptive throttling based on data store Key Performance Indicators (KPIs), including connection pool usage, response times, error rates, and defined limits.

4. The unified platform of claim 1, wherein the declarative model framework comprises:
a declarative object model and catalog configured to define and organize enterprise objects;
declarative execution services configured to orchestrate operations to create, modify, replicate, and propagate objects across services and data stores; and
a declarative model Application Programming Interface (API) enabling users and services to perform high-level, intent-based operations, including the creation, deletion, onboarding, and configuration of enterprise resources.

5. The unified platform of claim 1, wherein the CIM and the declarative model framework facilitate normalized declaration, discovery, sharing, and interaction with objects between different services, eliminating a need for application-specific schemas or workflows.

6. The unified platform of claim 1, wherein the unified platform comprises a versioned object protocol that is adapted to track changes to enterprise objects by creating a new object version for every update.

7. The unified platform of claim 1, wherein the shared services include a shared policy engine for defining, evaluating, and enforcing policy rules across cloud-based applications.

8. The unified platform of claim 1, wherein the shared services include an Artificial Intelligence (AI) / Machine Learning (ML) shared service for processing real-time telemetry, anomaly detection, and automated decision-making.

9. The unified platform of claim 1, wherein the shared services include a data analytics shared service for generating historical and real-time insights into system behavior, policy enforcement, and event outcomes.

10. The unified platform of claim 1, further comprising a versioned object cache for caching objects by version number, the versioned object cache supporting global and regional deployments, and capable of issuing near-real-time notifications for object version updates.

11. The unified platform of claim 1, wherein the one or more data stores include a persistent data store for storing enterprise objects, policies, and multi-tenant configurations.

12. The unified platform of claim 1, wherein the one or more data stores include a transient data store for streaming real-time data and caching results.

13. The unified platform of claim 1, further comprising a health and metrics reporting layer configured to:
collect and report system health metrics, including query latency, connection errors, and resource utilization;
integrate with external observability or monitoring systems to provide real-time diagnostics; and
operate independently of service-specific health reporting frameworks to ensure consistency across platform components.

14. A method for developing an application using a unified platform for developing and operating applications, the method comprising steps of:
defining one or more enterprise objects using a Common Information Model (CIM) of the unified platform to ensure standardization across one or more cloud services;
enabling the application to access data using a Data Access Layer (DAL) of the unified platform, wherein the data is abstracted from one or more physical data stores and uniformly managed across shards; and
enabling the application to leverage one or more shared services of the unified platform to eliminate redundant infrastructure development and enable feature reuse.

15. The method of claim 14, wherein the one or more enterprise objects include any of policies, events, and tenant configurations.

16. The method of claim 14, wherein the one or more shared services include any of a policy engine and an Artificial Intelligence (AI) / Machine Learning (ML) engine.

17. The method of claim 14, wherein the steps include configuring the application to respond to real-time events by receiving telemetry data processed through an AI/ML shared service, which publishes anomaly detections to an event store of the unified platform.

18. The method of claim 17, wherein the steps include configuring the application to evaluate an event against policy rules maintained through a shared policy engine of the unified service.

19. The method of claim 18, wherein the steps include configuring the application to enforce remediation actions based on matched policy rules, including actions such as updating firewall rules, blocking IP addresses, or generating admin alerts.

20. The method of claim 14, wherein all objects are versioned, ensuring compatibility between shared services of the unified platform.
